(19) United States
(12) Patent Application Publication
(10) Pub. No.: US 2004/0137901 A1
(43) Pub. Date: Jul. 15, 2004

(54) Vertical handover method by IP multicast

(76) Inventors: Ryutaro Hamasaki, Higashikurume-shi (JP); Shintaro Uno, Hachioji-shi (JP)

Correspondence Address: MOTOROLA, INC., 1303 EAST ALGONQUIN ROAD, IL01/3RD, SCHAUMBURG, IL, 60196

(21) Appl. No.: 10/340,982

(22) Filed: Jan. 13, 2003

(51) Int. Cl. H04Q 7/20

(52) U.S. Cl. 455/436; 455/438; 455/439; 455/440

(57) ABSTRACT

A communication system in which a mobile terminal MT communicates with a home agent HA by way of a cellular communication network and a WLAN includes a processor in communication with the HA and the cellular communication network. The MT communicates with the HA via the cellular communication network and the processor receives handover history information of the MT from the cellular communication network. As the MT moves within the cellular communication network, the processor predicts when the MT will enter an area covered by a WLAN and pre-registers the MT with the WLAN so that when the MT enters the WLAN covered area, the MT can immediately start receiving information from the WLAN. By having a processor perform the pre-registration, the radio resources of the MT are preserved.

### BACKGROUND OF THE INVENTION

The present invention relates generally to wireless communication systems, and more particularly, to user registration location management for mobile telecommunications systems.

Wireless Internet access via public hotspots is a fast-growing trend in the wireless communications industry. Coffee shops and public facilities, such as airports, are now providing fast, wireless network connections (Wi-Fi). Generally, available hot spot service areas are small and distant from each other. For example, hot spot service may be available near Wireless LAN (WLAN) Access Points (APs), which may be set at predetermined intervals along a highway or commuter rail route.

One problem with hot spot service is that the time required to perform location registration can severely limit the benefit of hot spot service. For example, suppose that a WLAN AP is set at the side of a highway and a mobile terminal MT (e.g., in a car) approaches the AP at high speed. At the moment the MT enters the hot spot, the MT will begin location registration and uplink communication. However, location registration and handover can take upwards of 30 seconds in some cases and downlink communication via the AP cannot start before the location registration is completed. Thus, the MT may move out of the hot spot before the location registration is completed. In such a case, the MT cannot receive any downlink data, even though broadband wireless communication service is available there.

One proposed solution is to provide an IP Multicast System with a Mobility Support Agent (MSA) architecture and a set of protocols to help decrease handover latency. Referring to FIG. 1, an example of the MSA architecture 10 is shown. The MSA architecture 10 includes first and second routers 12, 14 having respective base stations 16-22 for supporting a plurality of cells or networks 1-4. Respective MSA nodes 24, 26 are located in each IP network that supports seamless IP mobility. The MSA nodes 24, 26 advertise their presence and services using an Agent Discovery Protocol and Pre-registration protocol.

A mobile host MH 28 receives multicast traffic from the internet in its currently attached network. That is, the MH 28 accesses the Internet via the base station 18 of network 2 and the router 12 connected to the network 2 base station 18. When the MH 28 decides to perform a handover, it sends a pre-registration message using UDP to a neighboring network's MSA. In this example, the MH 28 sends a pre-registration message to the MSA 26. The pre-registration message includes the multicast groups the MH 28 is participating in. Once the MSA 26 receives the pre-registration message, the MSA 26 sends a message to the router 14, which triggers a join message to the upstream routers to establish a multicast tree. When the MH 28 arrives at network 3, multicast traffic is already available.

While tests show that the MSA architecture decreases handover latency, it still requires that the MH know to which WLAN AP (network) it is approaching and will switch. Thus, the MH must have an area map including network ID information or the MH must query the next AP ID using location information. Such a query requires radio resources and further, the MH may not be able to send the pre-registration message successfully if there is a bad radio connection.

It would be advantageous to provide improved downlink throughput and hot spot service registration, particularly for a mobile terminal moving at high speed.

### BRIEF DESCRIPTION OF THE DRAWINGS

The following detailed description of a preferred embodiment of the invention will be better understood when read in conjunction with the appended drawings. For the purpose of illustrating the invention, there is shown in the drawings an embodiment that is presently preferred. It should be understood, however, that the invention is not limited to the precise arrangement and instrumentalities shown. In the drawings:

FIG. 1 is a schematic diagram illustrating a prior art network configuration;

FIG. 2 is a schematic diagram illustrating a network configuration in accordance with an embodiment of the present invention;

FIG. 3 is flowchart of a mobile terminal MT hot spot registration procedure of the present invention;

FIG. 4 is a diagram illustrating a first example of a pre-registration procedure in accordance with an embodiment of the present invention; and

FIG. 5 is a diagram illustrating a mobile terminal leaving a hot-spot service area in accordance with the present invention.

### DETAILED DESCRIPTION OF PREFERRED EMBODIMENTS

The detailed description set forth below in connection with the appended drawings is intended as a description of the presently preferred embodiment of the invention, and is not intended to represent the only form in which the present invention may be practiced. It is to be understood that the same or equivalent functions may be accomplished by different embodiments that are intended to be encompassed within the spirit and scope of the invention. In the drawings, like numerals are used to indicate like elements throughout.

In one embodiment, the present invention provides a communication system in which a mobile terminal MT communicates with a home agent HA by way of a cellular communication network and a WLAN. The MT communicates with the HA via cellular communication network. The system includes a processor in communication with the HA and the cellular communication network. The processor receives handover history information of the MT from the cellular communication network. As the MT moves within the cellular communication network, the processor predicts when the MT will enter an area covered by a WLAN and pre-registers the MT with the WLAN so that when the MT enters the WLAN covered area, the MT may substantially immediately receive information from the WLAN.

In another embodiment, the present invention is a method of providing a handover of a mobile terminal MT between a cellular communications network and a WLAN. That is, in a wireless communications system in which a mobile terminal MT communicates with a home agent HA by way of a cellular communication network and a WLAN, the present invention provides a method of providing a handover between the cellular communication network and the WLAN. The method includes the steps of providing a handover history of the MT to a processor that is in communication with the cellular network. The processor predicts when the MT will move to an area covered by the WLAN and based on the prediction, the processor pre-registers the MT with the WLAN so that when the MT enters the WLAN covered area, the MT may substantially immediately receive information from the WLAN.

The present invention also provides a handover method in a wireless communications system, the system including a cellular network that provides wireless communication between a mobile terminal MT and a home agent HA by way of a plurality of base stations, and a wireless LAN (WLAN) that provides wireless communications between the MT and the home agent HA. The method includes the steps of:

providing a processor in communication with the cellular network and the home agent HA;

the cellular network providing a handover history of the MT to the processor;

the processor predicting when the MT will move to an area covered by the WLAN; and

based on the prediction, the processor pre-registering the MT with the WLAN so that when the MT enters the WLAN covered area, the MT may substantially immediately receive information from the WLAN.

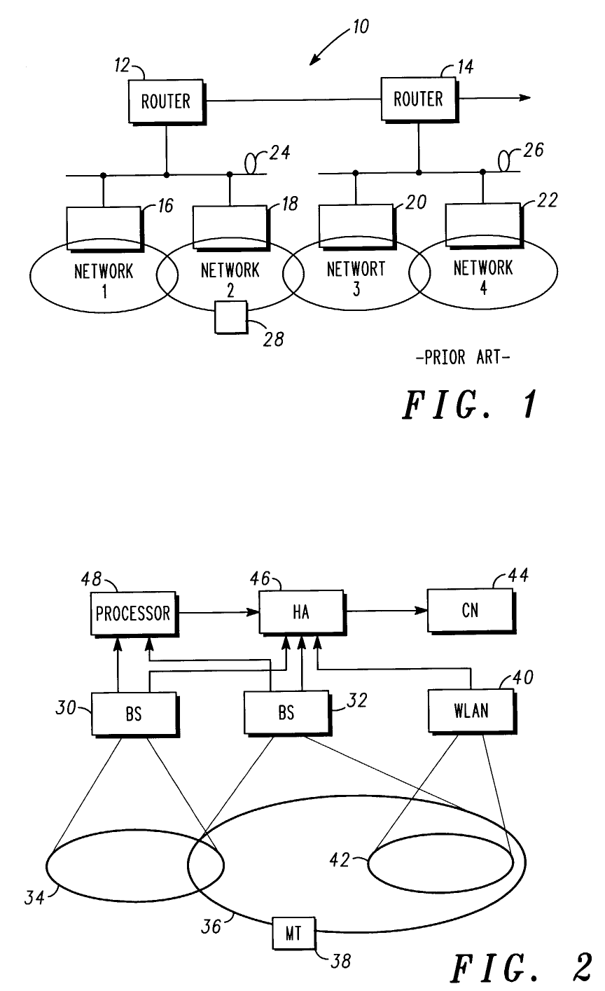

Referring now to FIG. 2, a schematic diagram illustrating a network configuration in accordance with an embodiment of the present invention. The network configuration includes first and second cellular base stations (BS) 30, 32 that define respective coverage areas or cells 34 and 36. The base stations 30, 32 are of a type commonly used in cellular telephone networks and known by those of ordinary skill in the art. The defined cells 34, 36 overlap so that a mobile terminal, such as the mobile terminal MT 38 may move from one cell to another and continue communicating via the network. The mobile terminal MT 38 is a dual-mode terminal capable of communication by cellular service and hot spot service. Usually the cellular service and hot spot service are managed by the same operator and roaming between the two services is permitted. The mobile terminal MT 38 may be a cellular telephone, such as a 3G cellular telephone, a PDA, or a laptop computer. As is understood by those of skill in the art, when the MT 38 is in the cell 34, it is in communication with the BS 30 and when the MT 38 is in the cell 36, it is in communication with the BS 32. The mobile terminal MT 38 preferably uses Mobile IP for mobility management. Thus, the MT 38 is also known as a mobile node (MN).

The network also includes a wireless local area network WLAN 40 that provides Internet access to devices such as the MT 38 within a coverage area 42, which is known as a “hot-spot.” The WLAN 40 generally provides a faster connection at a lower cost than the connection provided via the base station 32. Although the hot-spot or coverage area 42 is located within the cell 36, the coverage area 42 could be located outside of the cell 36 and within a different cell.

The MT 38 communicates with a correspondent node (CN) 44 by way of a home agent 46, which is in communication with the base stations 30, 32 and the WLAN 40 in a known manner. The CN 44 may be any computer on the Internet that communicates with the MT 38. The CN 44, because it communicates with the MT 38 by way of the Home Agent 46, does not need to know the care-of-address of the MT 38. As is known by those of skill in the art, the care-of-address of the MT 38 changes as the MT 38 moves between cells.

In accordance with the present invention, a processor or computer 48 is in communication with the base stations 30, 32 and the home agent 46. The computer 48 is provided to predict the movement of the MT 38. The computer 48 predicts the movement of the MT 38 using handover history information of the MT 38, which it receives from the base stations 30, 32 of the cellular network. The handover history may comprise location registration history information, which preferably comprises a predetermined number of the most recent location registrations of the MT 38. More specifically, the computer 48 predicts when the MT 38 will enter the area 42 covered by the WLAN 40 and pre-registers the MT 38 with the WLAN 40 so that when the MT 38 enters the WLAN covered area 42, the MT 38 may substantially immediately receive information from the WLAN 40. The computer 48 predicts which hot spot the MT 38 will enter a short time before the MT 38 enters the hot spot and then performs location registration of the MT 38 as the MT's proxy, thereby setting up the communication path between the MT 38 and the CN 44 via the WLAN 40.

An example of a communication sequence using FIG. 2 will now be described. At a first point in time, the MT 38, located in the cell 36 begins communicating with the CN 44 by way of the BS 32 and the HA 46. Periodically, the BS 32 passes to the computer 48 a handover history of the MT 38. The handover history of the MT 38 may be provided to the computer 48 periodically, such as at predetermined time intervals like every 5 minutes, or the handover history can be passed to the computer 48 after a handover is performed. The handover history passed to the computer 48 may comprise the last “n” handovers, where “n” is a whole number from 1-5. Alternatively, the handover history may comprise a predetermined number of minutes of the most recent communications by the MT, such as the last 10 seconds or the last ten (10) minutes of movement history of the MT 38. Other variations of handover history may be provided, so long as the information is sufficient for the computer 48 to predict with reasonable accuracy the movement of the MT 38, or more specifically, when the MT 38 will enter a hot-spot, such as the hot-spot 42. Preferably the BS 32 passes the history information to the computer 48 without any prompting by the MT 38. Moreover, the history information is preferably maintained by the BS 32 and not by the MT 38. Thus, communications of the MT 38 are not interrupted. Alternatively, the MT 38 may include a GPS receiver and periodically transmit its location to the base station of the cell in which it is located. The GPS position information can then be transmitted from the BS to the computer 48 in lieu of the handover history information and the computer 48 can use the GPS position information to calculate when the MT 38 will enter the hot-spot 42.

The computer 48 uses the handover history information to predict when the MT 38 will enter the hot-spot service area 42. Preferably, the computer 48 maintains a map of the cellular network and hot-spots so that the MT 38 need not be concerned with storing such information. The handover history provides a good indicator to track the movement of the MT 38 and predict where the MT 38 will be in the near future. The MT 38 movement is especially easily predicted in instances when the MT 38 is moving over a predefined route, such as a rail line or major roadway, such as a toll road. Using the prediction information, the computer 48 pre-registers the MT 38 with the WLAN 40 prior to the MT 38 entering the hot-spot 42. The pre-registration procedure includes binding on behalf of the MT 38. Pre-registration procedures are understood by those of skill in the art. Thus, originally the MT 38 communicates with the CN 44 with an Internet connection via the base station 32 and the home agent 46. When the MT 38 enters the hot spot 42, the MT 38 communicates with the CN 44 with an Internet connection via the WLAN 40 and the home agent 46 and because the MT 38 has been pre-registered with the WLAN 40 by the computer 48, the MT 38 can send and receive packets of information as soon as it enters the hot-spot 42.

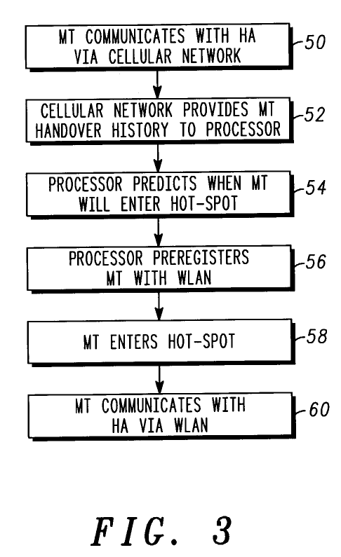

Referring now to FIG. 3, a flow chart of a mobile terminal MT hot spot registration procedure of the present invention. The first step 50 represents a mobile terminal in communication with a home agent via a cellular communications network. In step 52, the cellular network provides handover history information to a processor or computer that is in communication with the cellular network and the home agent. In lieu of handover history information, GPS location information of the MT, if available, could be passed to the computer. The important factor is that information from which the computer can predict when the MT will enter an area, e.g., a hot-spot where the MT can access the Internet via a WLAN, is passed from the cellular network to the computer. In step 54, the computer predicts when the MT will enter a hot-spot using the handover information and data concerning the locations of hot-spots, such as pre-stored database of hot-spot service locations. Then, in step 56, the computer pre-registers the MT with the WLAN supporting the hot-spot that the computer has predicted the MT will soon enter. In step 58, the MT enters the hot-spot and in step 60, the MT communicates with the HA via the WLAN. Since the MT has been pre-registered, the MT can substantially immediately start sending and receiving packets via the WLAN.

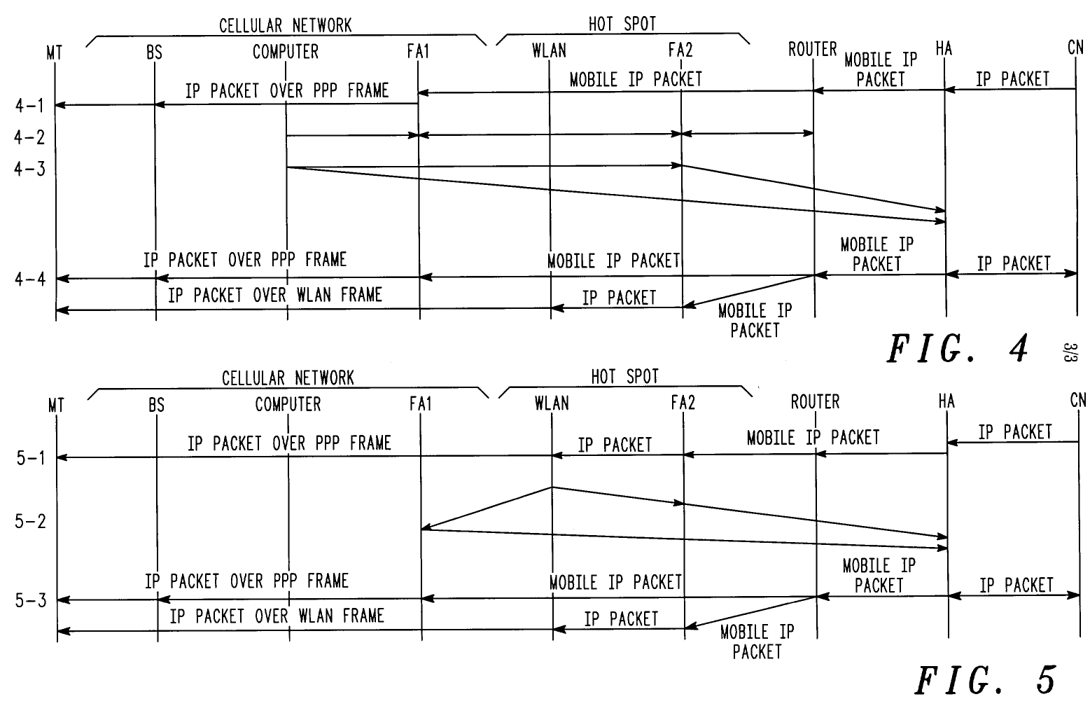

Referring now to FIG. 4, a diagram illustrating a first example of a pre-registration procedure in accordance with an embodiment of the present invention is shown. In the example, data is passed between a mobile terminal MT, a cellular base station BS, a computer, a first foreign agent FA1, a wireless LAN (WLAN), a second foreign agent FA2, a multicast router, a home agent HA and a correspondent node CN. The base station BS, computer and first foreign agent FA1 form a cellular network and the WLAN and second foreign agent FA2 are part of a hot-spot coverage area. The transmission of data between such devices and the formats and protocols for such data transmission are known by those of skill in the art. At step 4-1, information is passed from the CN to the MT in IP Packet form. At step 4-2, the computer, using MT history information received from the BS, predicts that the MT will soon enter the hot-spot. In this example, the term soon refers to about 10 seconds, although the range of time allotted for prediction and pre-registration may vary. Thus, the invention is not meant to be limited by predicting the MT will enter a hot-spot within 10 seconds time. After the computer predicts that the MT will soon enter the hot-spot, the computer determines an IP Multicast address that includes a unicast IP address for FA1 and a unicast IP address for FA2. At 4-3, the computer instructs the home agent HA to register the IP multicast address as the MT's Care of Address. At 4-4, the MT has entered the hot-spot service area. At this time, the MT receives the same data packet over the cellular network as a PPP frame and over the WLAN as a WLAN frame. That is, the MT receives redundant packets. Although not required, in order to decrease the risk of dropping data, it is preferred to send redundant packets until after the MT has entered the hot-spot.

Referring now to FIG. 5, a diagram illustrating a second example of a MT leaving a hot-spot service area in accordance with the present invention is shown. As in the previous example, data is passed between a mobile terminal MT, a cellular base station BS, a computer, a first foreign agent FA1, a wireless LAN (WLAN), a second foreign agent FA2, a multicast router, a home agent HA and a correspondent node CN. The base station BS, computer and first foreign agent FA1 form a cellular network and the WLAN and second foreign agent FA2 are part of a hot-spot coverage area. At step 5-1, information is passed from the CN to the MT in IP Packet form over the WLAN. At step 5-2, the WLAN detects that that radio strength of a frame received from the MT is too weak. That is, the signal strength is less than a predetermined threshold value. Accordingly, the WLAN instructs the home agent HA to register the IP multicast address as the MT's Care of Address. Then, at 5-3, the MT receives the same data packet over the cellular network as a PPP frame and over the WLAN as a WLAN frame. That is, the MT receives redundant packets to ensure that as the MT leaves the hot-spot coverage area data is not dropped.

A key point of the present invention is that the pre-registration is performed by the computer 48 in the cellular network. The computer 48 determines candidate hot spots that the MT 38 may enter and the computer 48 performs the location registration as a proxy for the MT 38. That is, the MT 38 does not need to know location or neighboring base station information, nor must the MT 38 transmit a pre-registration message. Thus, valuable air-time or frequency bandwidth is reserved. In contrast, prior art systems communicate location information from the base station to the mobile host using RF or cellular resources.

The description of the preferred embodiments of the present invention have been presented for purposes of illustration and description, but are not intended to be exhaustive or to limit the invention to the forms disclosed. Although the invention is described in terms of separate processing components, it will be understood by those of skill in the art the that invention may be implemented in hardware, software, or a combination of hardware and software. Thus, changes could be made to the embodiments described above without departing from the broad inventive concept thereof. It is understood, therefore, that this invention is not limited to the particular embodiments disclosed, but covers modifications within the spirit and scope of the present invention as defined by the appended claims.

1. A communication system in which a mobile terminal MT communicates with a home agent HA by way of a cellular communication network and a WLAN, the system comprising:
a processor in communication with the HA and the cellular communication network, wherein the processor receives handover history information of the MT from the cellular communication network; and
wherein as the MT moves within the cellular communication network, the processor predicts when the MT will enter an area covered by a WLAN and pre-registers the MT with the WLAN so that when the MT enters the WLAN covered area, the MT may substantially immediately receive information from the WLAN.

2. The communication system of claim 1, wherein the MT communicates with a correspondent node by way of the home agent HA.

3. The communication system of claim 1, wherein the pre-registration comprises binding on behalf of the MT.

4. The communication system of claim 1, wherein the handover history information comprises a predetermined number of minutes of the most recent communications by the MT.

5. The communications system of claim 4, wherein the predetermined number of minutes is about ten (10).

6. The communications system of claim 1, wherein the handover history comprises location registration history information.

7. The communications system of claim 6, wherein the location registration history information comprises a predetermined number of the most recent location registrations of the MT.

8. The communications system of claim 1, wherein the handover history comprises GPS data.

9. In a wireless communications system in which a mobile terminal MT communicates with a home agent HA by way of a cellular communication network and a WLAN, a method of providing a handover between the cellular communication network and the WLAN comprising the steps of:
providing a handover history of the MT to a processor that is in communication with the cellular network;
the processor predicting when the MT will move to an area covered by the WLAN; and
based on the prediction, the processor pre-registering the MT with the WLAN so that when the MT enters the WLAN covered area, the MT may substantially immediately receive information from the WLAN.

10. The handover method of claim 9, wherein the MT communicates with a correspondent node by way of a home agent HA connected to the cellular communication network and the WLAN.

11. The handover method of claim 9, wherein the pre-registration comprises binding on behalf of the MT.

12. The handover method of claim 9, wherein the handover history information comprises a predetermined number of minutes of the most recent communications by the MT.

13. The handover method of claim 12, wherein the predetermined number of minutes is about ten (10).

14. The communications system of claim 9, wherein the handover history comprises location registration history information.

15. The communications system of claim 14, wherein the location registration history information comprises a predetermined number of the most recent location registrations of the MT.

16. A handover method in a wireless communications system, the system including a cellular network that provides wireless communication between a mobile terminal MT and a home agent HA by way of a plurality of base stations, and a wireless LAN (WLAN) that provides wireless communications between the MT and the home agent HA, the method comprising the steps of:
providing a processor in communication with the cellular network and the home agent HA;
the cellular network providing a handover history of the MT to the processor;
the processor predicting when the MT will move to an area covered by the WLAN; and
based on the prediction, the processor pre-registering the MT with the WLAN so that when the MT enters the WLAN covered area, the MT may substantially immediately receive information from the WLAN.

17. The handover method of claim 16, wherein the MT communicates with a correspondent node by way of the home agent HA.

18. The handover method of claim 16, wherein the processor communicates directly with the base stations of the cellular network to receive the MT history information.

19. The handover method of claim 16, wherein the handover history comprises location data of the MT.

20. The handover method of claim 19, wherein the location data is received by the cellular network from the MT.

21. The handover method of claim 16, further comprising the step of:
after the MT is pre-registered with the WLAN, sending duplicate data to the MT over the cellular network and the WLAN.
